(19) United States
(12) Patent Application Publication
(10) Pub. No.: US 2007/0230800 A1
(43) Pub. Date: Oct. 4, 2007

(54) Visibility range measuring apparatus for vehicle and vehicle drive assist system

(75) Inventor: Takayuki Miyahara, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/729,436

(22) Filed: Mar. 28, 2007

(30) Foreign Application Priority Data
Mar. 29, 2006 (JP) 2006-092363

(51) Int. Cl. G06K 9/62; H04N 7/18; B60Q 1/00; G01W 1/00; G05D 1/00

(52) U.S. Cl. 382/224; 348/148; 340/425.5; 340/601; 701/1

(57) ABSTRACT

A visibility range measuring apparatus for a vehicle includes an image capturing device, an image computing device, and a visibility range calculating device. The image capturing device captures first and second images of a road, each of which includes a target roadside object, from the vehicle at first and second image taking points, respectively, along the road at a time of driving the vehicle along the road. The image computing device computes an image feature of the captured target roadside object in the first image and an image feature of the captured target roadside object in the second image. The visibility range calculating device calculates a visibility range from the vehicle based on the image features of the captured target roadside object in the first and second images, and a distance between the first and second image taking points.

### CROSS REFERENCE TO RELATED APPLICATION

This application is based on and incorporates herein by reference Japanese Patent Application No. 2006-92363 filed on Mar. 29, 2006.

### BACKGROUND OF THE INVENTION

1. Field of the Invention

The present invention relates to a visibility range measuring apparatus for a vehicle and a vehicle drive assist apparatus.

2. Description of Related Art

It is conventionally proposed that a visibility range is measured using image information obtained from an image taking means (e.g., a camera) (e.g., JP63-188741A, JP2001-84377A2, and JP11-326200A2 (corresponding to U.S. Pat. No. 6,128,088)). According to JP63-188741A, a two-toned (black and white-painted) index is installed on a road shoulder or the like. A light-shade contrast of the index is detected from a predetermined distance. The visibility range is measured based on this light-shade contrast that is detected and a light-shade contrast when viewed from an extremely short distance.

With respect to JP2001-84377A2, an image of a predetermined areas in which a judgment marker is installed, is taken. A visibility evaluation value is calculated based on image features (e.g., a luminance level, edge intensity, a frequency component, and a color component) of this judgment marker area.

Also, in JP11-326200A2, luminances of lane-dividing mark lines at a plurality of points, distances of which from a vehicle differ from each other, are detected using picture signals from a camera that is mounted on the vehicle. The visibility range is calculated by making a comparison among the luminances that are detected. For example, the visibility range is calculated based on the luminances of the picture signals Dg_{L1}, Dg_{L2}, which correspond to the lane-dividing mark lines at distances of L₁, L₂ from the camera, respectively.

However, in JP63-188741A, since the visibility range is measured using the light-shade contrast of the index that is installed at the predetermined distance from a camera that sends the image information to an image processor to calculate the light-shade contrast, the visibility range cannot be measured unless the index is installed at the predetermined distance beforehand. Furthermore, the image information about a standing tree at a known distance from the camera is regarded as the index. Nevertheless, the visibility range cannot be measured unless a position of the standing tree from the camera is known.

As well, because the judgment marker is employed in JP2001-84377A2, the visibility evaluation value cannot be calculated unless the judgment marker is installed in advance. In addition, the luminances of the lane-dividing mark lines are detected in JP11-326200A2, and thus the visibility range cannot be calculated on a road, on which the lane-dividing mark line is not painted.

Accordingly, conventional arts as described above have a disadvantage that the visibility range can be measured only on a specific road, on which the index, the judgment marker, the lane-dividing mark line or the like is previously installed.

### SUMMARY OF THE INVENTION

The present invention addresses the above disadvantages. Thus, it is an objective of the present invention to provide a visibility range measuring apparatus for a vehicle, which calculates a visibility range in a more effective way. It is another objective of the present invention to provide a vehicle drive assist system having such a visibility range measuring apparatus.

To achieve the objective of the present invention, a visibility range measuring apparatus for a vehicle is provided. The visibility range measuring apparatus includes an image capturing means, an image computing means, and a visibility range calculating means. The image capturing means is for capturing first and second images of a road, each of which includes a target roadside object, from the vehicle at first and second image taking points, respectively, along the road at a time of driving the vehicle along the road. The image computing means is for computing an image feature of the captured target roadside object in the first image, and an image feature of the captured target roadside object in the second image. The visibility range calculating means is for calculating a visibility range from the vehicle based on the image feature of the captured target roadside object in the first image, the image feature of the captured target roadside object in the second image, and a distance between the first image taking point and the second image taking point on the road.

To achieve the objective of the present invention, a vehicle drive assist system, which includes the visibility range measuring apparatus and a drive assisting means, is also provided. The drive assisting means is for assisting a driver of the vehicle with a drive operation of the vehicle using the visibility range, which is measured by the visibility range measuring apparatus.

Furthermore, a vehicle drive assist system, which includes the visibility range measuring apparatus and a front information providing means, is provided. The front information providing means is for providing information about a state ahead of the vehicle to a driver of the vehicle using the visibility range, which is measured by the visibility range measuring apparatus.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view illustrating overall construction of a visibility range measuring apparatus for a vehicle according to an embodiment of the present invention;

FIG. 2 is a schematic view illustrating a state, where front images that fall within an image capturing range, which is set to include a roadside object while a vehicle is running, are repeatedly taken;

FIG. 3 is a block diagram showing a configuration of an image processor of the visibility range measuring apparatus;

FIG. 4A is an illustrative view showing a distant image that is taken when a roadside object is located at a large distance from a vehicle;

FIG. 4B is an illustrative view showing a near image that is taken when the roadside object, which is shown in the distant image, is located adjacent to the vehicle;

FIG. 5 is a schematic diagram that shows a relationship between a forward distance to a roadside object and edge intensity of a front image that captures the roadside object when the front image is taken from a vehicle;

FIG. 6 is a schematic diagram that shows a visibility range conversion table to calculate a visibility range from a relationship between an edge intensity difference and a travel distance of a vehicle;

FIG. 7 is a flowchart showing a flow of an operation of an image processor in the visibility range measuring apparatus;

FIG. 8 is a schematic diagram that shows a relationship between an edge intensity difference and a travel distance of a vehicle when a margin is allowed for the edge intensity difference, which corresponds to the travel distance of the vehicle, according to a first modification of the embodiment; and

FIG. 9 is a schematic diagram that shows a conversion table to calculate a visibility range from a relationship between a frequency component value difference and a travel distance of a vehicle, according to a second modification of the embodiment.

### DETAILED DESCRIPTION OF THE INVENTION

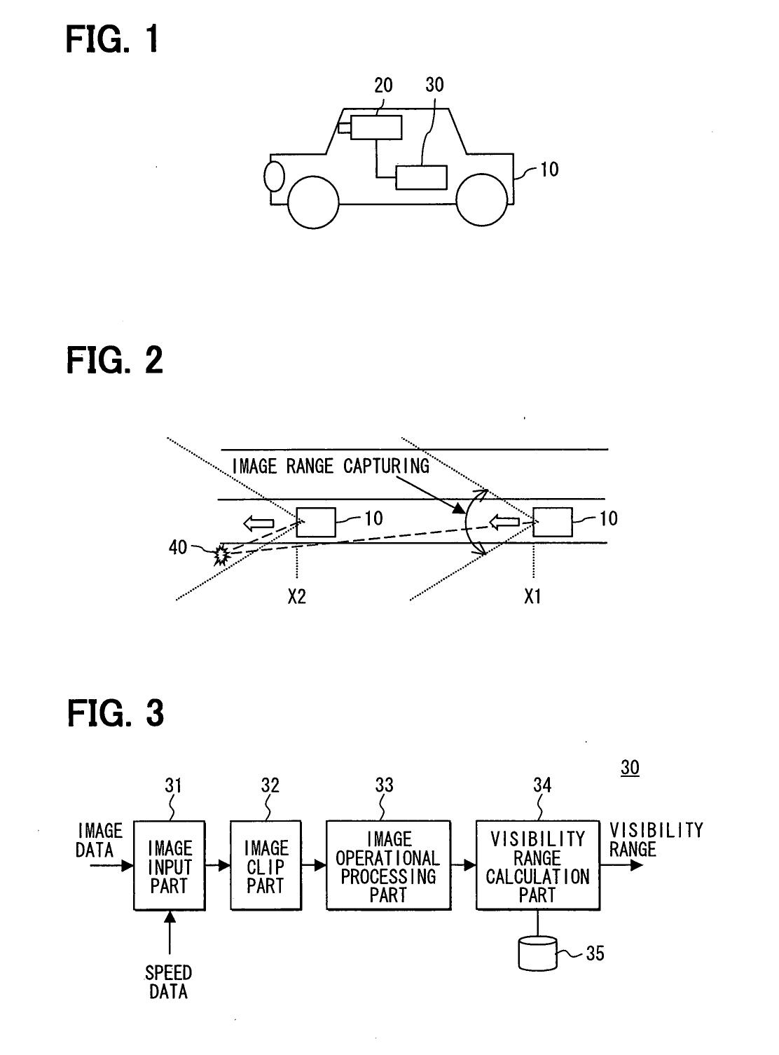

An embodiment of a visibility range measuring apparatus for a vehicle will be described below with reference to the accompanying drawings. FIG. 1 shows overall construction of the visibility range measuring apparatus for the vehicle in the present embodiment. As shown in FIG. 1, the visibility range measuring apparatus is mounted on a vehicle 10, and includes a camera (an image capturing means) 20 and an image processor 30. The camera 20 is, for example, a visible imaging camera that incorporates an image sensor such as a charge-coupled device (CCD) and is installed in the interior of the vehicle 10. The employment of the visible imaging camera for the camera 20 allows taking an image, which captures approximately the same state as is visually recognized by a driver of the vehicle 10.

The camera 20 can regulate a shutter speed, a frame rate, a gain of image signals that is outputted to the image processor 30, and the like, in response to a command from a controller (not shown) included in the camera 20. The camera 20 outputs a digital signal of image data, which indicates a degree of luminance (i.e., pixel value) of each pixel of an image that is taken, to the image processor 30, together with horizontal and vertical synchronizing signals of the image. Additionally, if the image processor 30 (which will be hereinafter described in detail) outputs a visibility range, set values (i.e., the shutter speed, the frame rate, the gain of image signals) of an image that is outputted to the image processor 30 are stored.

As shown in FIG. 2, an image capturing range of the camera 20 is set to include a roadside object (a target roadside object) 40 on a road that extends ahead of the vehicle 10. The camera 20 repeatedly takes front images that fall within the image capturing range at intervals of an image taking period τ. Consequently, a plurality of images that capture the identical roadside object 40 is taken from a plurality of image taking points (i.e., X1, X2), which differ in distances to the roadside object 40.

As shown in FIG. 3, the image processor 30 includes an image input part 31, an image clip part (a subject image area setting means) 32, a image operational processing part (an image computing means) 33, a visibility range calculation part (a visibility range calculating means) 34, and a visibility range conversion table 35. The image data (hereafter referred to as front image data) about the front images that are repeatedly taken by the camera 20 is inputted into the image input part 31. As well, speed data on the vehicle 10 is inputted into the image input part 31 via an in-vehicle LAN (not shown) or the like. Then, the image input part 31 correlates the received front image data with the received speed data, and stores them sequentially in a storage (not shown). Also, on receiving a command from the image clip part 32, the image input part 31 retrieves the front image data and the speed data from the storage to output them to the image clip part 32.

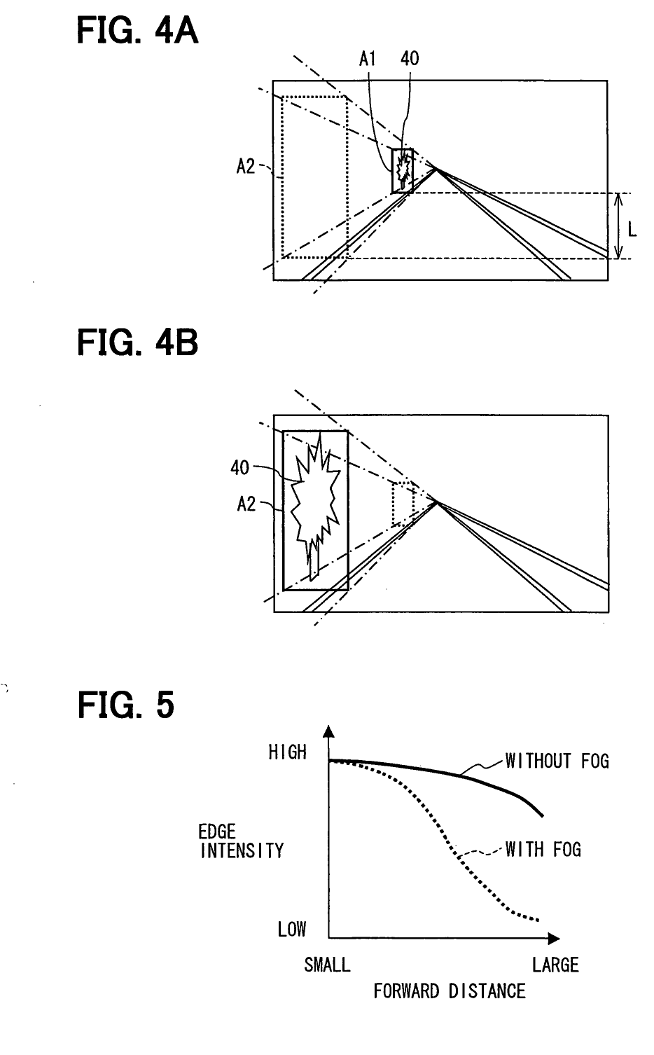

From the front image data stored on the storage of the image input part 31, a plurality of the front image data about the front images that capture the identical roadside object 40, and that differ in their image taking points is selected and inputted into the image clip part 32. For each one of the plurality of the front images, the image clip part 32 sets a corresponding image area, and an operation is to be performed on each image area to obtain a corresponding image feature (which will be described below). Then, the image clip part 32 clips this image area that is set, and outputs it to the image operational processing part 33. By referring to FIGS. 4A, 4B, procedures for setting the image area will be described below.

FIG. 4A shows the front image (hereafter referred to as a far image or a first image) that is taken when the roadside object 40 is located at a large distance from the vehicle 10 (i.e., that is taken at the image taking point (a first image taking point) X1 in FIG. 2). FIG. 4B is the front image that is taken N frames after the far image of FIG. 4A is taken. FIG. 4B shows the front image (hereafter referred to as a near image or a second image) that is taken when the roadside object 40, which is captured in the far image, is located adjacent to the vehicle 10 (i.e., that is taken at the image taking point (a second image taking point) X2 in FIG. 2).

The image clip part 32 sets an image area (a first subject image area) A1, on which the operation is performed to obtain an image feature of the roadside object 40, for the far image of FIG. 4A. The image area A1 does not specify a position of the roadside object 40 in the far image, but is set around the periphery of the roadside, which is at the large distance from the vehicle 10. This is for the following reason. Generally, there are roadside objects of some kind (e.g., a standing tree, a road sign, a guardrail, and a curbstone) at the periphery of the roadside. By setting the image area A1 around the periphery of the roadside, which is at the large distance from the vehicle 10, at least the roadside object 40 of some kind is captured in the image area A1, since the image area, in which the periphery of the roadside is captured, is secured in the front image if the vehicle 10 is running on a flat straight road.

In view of, for example, resolution (i.e., resolving power) of the front image, the image clip part 32 sets the image area A1 around the periphery of the roadside, which is at the large distance from the vehicle 10. For instance, if the front image has high resolution, the image area A1 of small size may be set at the large distance from the vehicle 10, whereas that of large size may be set at a small distance from the vehicle 10 if the front image has low resolution. In addition, if required parameters, such as a gradient, cant, curvature radius, of the road ahead of the vehicle 10, are known, the image area A1 may be set in light of those parameters.

Once the image area A1, in which the roadside object 40 is captured, is set for the far image as shown in FIG. 4A, a future locus of the image area A1 (i.e., a future locus of the roadside object 40) can be geometrically estimated while the vehicle 10 is running toward the roadside object 40 on the flat straight road. A future position of the image area A1 exists on a locus indicated by a dashed-dotted line in FIG. 4A. Additionally, if the required parameters, such as the gradient, cant, curvature radius, of the road ahead of the vehicle 10, are known, the future locus of the image area A1 can be calculated in view of these parameters, even if the vehicle 10 is not running on the flat straight road.

Thus, the image clip part 32 obtains an image area (a second subject image area) A2 in the near image that is taken after the elapse of time T (T=τ×N), from the future locus of the image area A1 in the far image as shown in FIG. 4A. The image area A2 is obtained, such that it is positioned at the small distance from the vehicle 10 and falls within a range of the near image. More specifically, by calculating a distance L to the image area A2 from the image area A1 using the following equation, a position of the image area A2 is obtained. Additionally, a variable V in the equation expresses an average vehicle speed between the speed data, which is related to the far image, and the speed data, which is related to the front image (i.e., the near image) that is taken after the elapse of N frames from the far image.

L=V×τ×N

L in the above equation 1 expresses a distance between the image taking point X1, at which the distant image is taken, and the image taking point X2, at which the near image is taken N frames after the far image is taken. In other words, it expresses a travel distance of the vehicle 10 after the far image is taken until the near image (which is taken N frames after the distant image is taken) is taken. As a result, the distance between two image taking points can be measured with no need to include a device for the distance measurement in the visibility range measuring apparatus. Alternatively, the travel distance of the vehicle 10 may be obtained by converting a pulse count of a speed pulse into a distance.

Based on the equation 1, the number (N) of frames taken after the taking of the far image is determined. Then, the front image data about the front image, which is taken N frames after the far image is taken, is inputted into the image clip part 32. As shown in FIG. 4B, for this front image (i.e., the near image) that is inputted, the image clip part 32 sets the image area A2, which is obtained from the future locus of the image area A1 in the far image.

In this manner, the image clip part 32 sets the image areas A1, A2 in the far and near images that are taken at the image taking points X1, X2, respectively. Then, the operation is to be performed on each of the image areas A1, A2 to obtain the corresponding image feature of the identical roadside object 40. Meanwhile, as described above, after the image area A1 is set for the far image, which is taken at the image taking point X1 that is at the large distance from the roadside object 40, the image area A2 is set for the near image based on this position of the image area A1, and on the distance between the image taking points X1, X2, at which the far and near images are taken respectively.

This is the reason that a corresponding part of the near image to the position of the image area A1, which is set for the far image, can be geometrically obtained, if the distance between the two image taking points, at which their corresponding front images (i.e., the near and far images) are taken, is obtained.

Conversely, if the distance between the two image taking points, at which their corresponding front images are taken, is obtained, a position of the image area A1 in the distant image, which corresponds to the position of the image area A2 in the near image, can be also geometrically obtained. Therefore, after the image area A2 is set for the near image that is taken at the image taking point X2, which is at the small distance from the roadside object 40, the image area A1 may be set for the far image based on this position of the image area A2, and on the distance between the image taking points X1, X2, at which the far and near images are taken, respectively.

The image operational processing part 33 computes edge intensity (as the image feature) in each of the image areas A1, A2, which are outputted from the image clip part 32, in a horizontal (or vertical) direction, and outputs it to the visibility range calculation part 34. Since the image areas A1, A2 differ in their sizes, the image operational processing part 33 performs, for example, normalization in order that a size of the image area A2 is reduced to the same as that of the image area A1, thereby computing the edge intensity.

The term, edge intensity will be explained here. The edge intensity expresses a degree of variation in the pixel value of each two of adjacent pixels, and indicates a sense of sharpness of an image. For instance, when a comparison is made between an image (i.e., a sharp image), in which the roadside object on the road that extends ahead of the vehicle 10 is sharply shown, and an image (i.e., an unsharp image), in which the roadside object is unsharply shown, the sense of sharpness (i.e., intensity of the edge) of a border, which divides the roadside object from its periphery, is felt more significantly in the sharp image than in the unsharp image. Accordingly, the edge intensity indicates the sense of sharpness of an image.

In addition, the edge intensity may be expressed in, for example, an average of the image area from which the edge intensity is obtained, or statistics of its distribution.

In this manner, the image operational processing part 33 computes the image feature in the image area A1 that is set in the far image, and the image feature in the image area A2 that is set in the near image. As a result, in the far and near images, the image areas (on each of which the operation is performed to obtain its corresponding image feature) are limited to those areas in which the identical roadside object 40 is shown. Consequently, the load on operation processing of the image features can be reduced.

The visibility range calculation part 34 computes a difference (hereafter referred to as an edge intensity difference) between the edge intensity of the image area A1 and that of the image area A2. Based on the edge intensity difference, the visibility range is calculated. FIG. 5 shows a relationship between a forward distance from the vehicle 10 to the roadside object 40 and the edge intensity of the front image, which is taken from the vehicle 10, and in which the roadside object 40 is captured. A dotted line indicates the relationship between the forward distance and the edge intensity when a fog lies ahead of the vehicle 10 (i.e., when the visibility range is short). A continuous line indicates the relationship between the forward distance and the edge intensity when the fog does not lie ahead of the vehicle 10 (i.e., when the visibility range is long).

As can be seen from FIG. 5, if the fog does not lie (i.e., if the visibility range is long), there is not a significant change in the edge intensity of the front image even when the forward distance becomes large (i.e., even when the roadside object 40 is located at the large distance from the vehicle 10), so that high edge intensity can be obtained. On the other hand, if the fog does lie (i.e., if the visibility range is short), there is a significant change in the edge intensity of the front image when the forward distance becomes large (i.e., when the roadside object 40 is located at the large distance from the vehicle 10), so that the edge intensity turns from high to low as the roadside object 40 is located at a larger distance from the vehicle 10.

Accordingly, between the edge intensity of the image area A1 of the far image taken at the image taking point X1, and that of the image area A2 of the near image taken at the image taking point X2 while the vehicle 10 is running toward the roadside object 40 on the road as shown in FIG. 2, their edge intensity difference becomes small when the visibility range becomes long (i.e., their edge intensity difference becomes large when the visibility range becomes short).

Furthermore, the edge intensity difference becomes large when the distance (i.e., the travel distance of the vehicle 10) between the image taking points X1, X2 becomes large (i.e., when the distance between the image taking points X1, X2 becomes small, the edge intensity difference becomes small). In addition to this, the above trend becomes more marked when the visibility range becomes shorter.

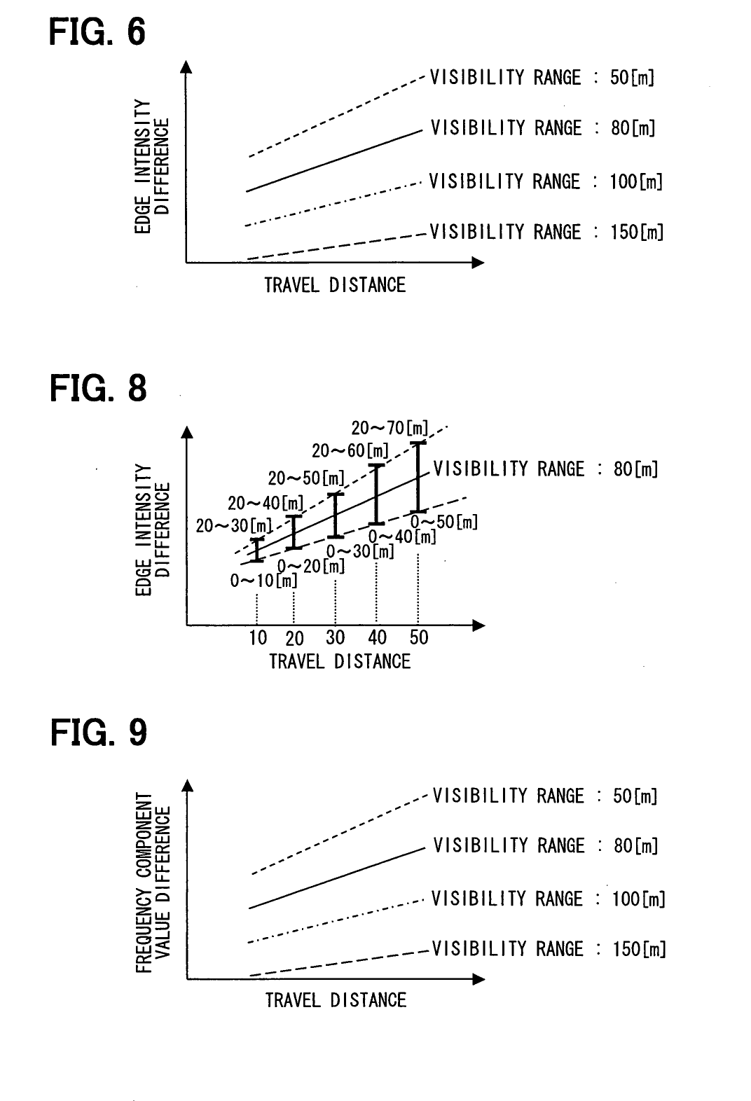

Consequently, the visibility range can be estimated if a relationship between the edge intensity difference and the travel distance of the vehicle 10 is determined. Thus, in the present embodiment, the visibility range is calculated from the edge intensity difference between the image areas A1, A2, and the travel distance of the vehicle 10 using a conversion table (FIG. 6).

The visibility range calculation part 34 stores the conversion table in FIG. 6 on the visibility range conversion table 35, and calculates the visibility range from the relationship between the edge intensity difference and the travel distance of the vehicle 10. On calculating the visibility range, the visibility range calculation part 34 outputs the visibility range to various application systems, which are mounted on the vehicle 10 via the in-vehicle LAN (not shown).

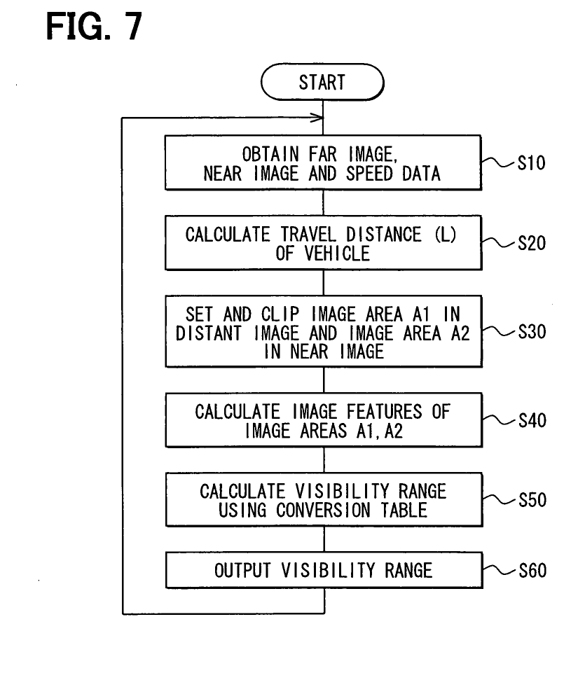

Next, with reference to a flowchart in FIG. 7, an operation of the image processor 30 in the visibility range measuring apparatus for a vehicle of the present embodiment will be described below. To begin with, the far image, the near image, and the speed data are obtained at step S10. At step S20, the travel distance of the vehicle 10 after the far image is taken until the near image is taken is calculated.

At step S30, the image area A1 in the far image and the image area A2 in the near image are set and clipped. At step S40, the image features in the image areas A1, A2 are computed. The visibility range is calculated using the conversion table at step S50, and the visibility range that is calculated is outputted at step S60. After step S60, steps S10 to S60 are repeatedly executed.

In this manner, in the far and near images, in which the identical roadside object 40 is captured, and which are taken at a plurality of image taking points (X1, X2, respectively), the visibility range measuring apparatus for a vehicle sets the respective image areas A1, A2. On each of the image areas A1, A2, the operation is performed to obtain its corresponding edge intensity of the roadside object 40. Then, the visibility range measuring apparatus calculates the visibility range from the vehicle, based on the edge intensity difference between the image areas A1, A2, and on the distance (i.e., the travel distance of the vehicle 10) between the image taking points X1, X2. As a consequence, the visibility range can be calculated irrespective of roads, on which the vehicle 10 is running.

Thus far, the embodiment of the present invention has been described. Nevertheless, the present invention is not by any means limit to the above embodiment, and it can be embodied by making various changes without departing from the scope of the present invention.

### (First Modification)

The edge intensity shown in FIG. 5 manifests nonlinear properties both when the fog does not lie (indicated with the continuous line) and when the fog lies (indicated with the dotted line). Hence, it follows that despite the same distance (i.e., the travel distance of the vehicle) between two image taking points, the edge intensity difference varies according to variations in positions of starting the taking of the front image and ending the taking of the image. For this reason, as shown in a conversion table of FIG. 8, a certain margin may be allowed for the edge intensity difference that corresponds to the travel distance of the vehicle 10. Using this conversion table, the visibility range can be calculated in view of the nonlinear properties of the edge intensity.

### (Second Modification)

The visibility range is calculated based on the edge intensity difference between the image areas A1, A2 in the present embodiment. Alternatively, after obtaining each frequency component of the pixel value of a corresponding one of the image areas A1, A2, the visibility range may be calculated from difference (hereafter referred to as frequency component value difference) between these frequency component values of the image areas A1, A2.

For example, when the comparison is made between the image (i.e., the sharp image), in which the roadside object on the road that extends ahead of the vehicle 10 is sharply shown, and the image (i.e., the unsharp image), in which the roadside object is unsharply shown, the sense of sharpness (i.e., the intensity of the edge) of the border, which divides the roadside object from its periphery, is felt more significantly in the sharp image than in the unsharp image. Consequently, when the frequency components of the pixel values of both the images are analyzed, the sharp image has more high-frequency components than the unsharp image.

Because of this, the visibility range may be calculated using a conversion table of FIG. 9 to calculate the visibility range from the frequency component value difference (instead of the edge intensity difference between the image areas A1, A2) between the pixel values of the image areas A1, A2, and from the travel distance of the vehicle 10.

### (Third Modification)

The visibility range is calculated by taking the front image in the present embodiment. Alternatively, by installing the camera 20 in the vehicle 10 such that it takes a rear image, in which the roadside object located behind the vehicle 10 is captured, the visibility range may be calculated from this rear image.

### (Fourth Modification)

In addition, the driver of the vehicle may be assisted in his/her drive operation by a drive assisting means, using the visibility range that is calculated by the visibility range measuring apparatus for a vehicle. If the visibility range is short, fog lamps or head lamps of the vehicle, for example, may be automatically turned on.

### (Fifth Modification)

Moreover, using the visibility range that is measured by the visibility range measuring apparatus for a vehicle, information about a state ahead of the vehicle may be provided by a front information providing means. For instance, using the visibility range, the information about a state (e.g., a curve, a point of intersection, stopped traffic, and oncoming traffic) that is ahead of the vehicle and is unviewable from the driver of the vehicle, may be provided to the driver. This information may be provided based on various pieces of information (e.g., positional information about the driver's own vehicle and about an obstruction, and map information) obtained from the other in-vehicle devices (e.g., a navigational device and millimeter-wave radar). In addition, the front information providing means may include an information provision timing changing means. More specifically, in providing the information about the state ahead of the vehicle, a timing, with which the information is provided, may be changed by the information provision timing changing means based on the visibility range. For instance, when the visibility range is short, earlytiming leads to early provision of the information about the state that is ahead of the vehicle and is unviewable from the driver, so that the driver can have a sense of safety.

Additional advantages and modifications will readily occur to those skilled in the art. The invention in its broader terms is therefore not limited to the specific details, representative apparatus, and illustrative examples shown and described.

1. A visibility range measuring apparatus for a vehicle, comprising:
image capturing means for capturing first and second images of a road, each of which includes a target roadside object, from the vehicle at first and second image taking points, respectively, along the road at a time of driving the vehicle along the road;
image computing means for computing an image feature of the captured target roadside object in the first image and an image feature of the captured target roadside object in the second image; and
visibility range calculating means for calculating a visibility range from the vehicle based on:
the image feature of the captured target roadside object in the first image;
the image feature of the captured target roadside object in the second image; and
a distance between the first taking point and the second image taking point on the road.

2. The visibility range measuring apparatus according to claim 1, further comprising subject image area setting means for setting a first subject image area in the first image and a second subject image area in the second image, wherein:
the first subject image area and the second subject image area include the captured target roadside object and are generally homothetic to each other; and
the image computing means computes the image feature of the captured target roadside object in the first subject image area in the first image and the image feature of the captured target roadside object in the second subject image area in the second image.

3. The visibility range measuring apparatus according to claim 2, wherein:
the first image taking point is located at a first distance from the target roadside object along the road;
the second image taking point is located at a second distance from the target roadside object along the road, wherein the second distance is smaller than the first distance; and
the subject image area setting means sets the first subject image area in the first image first, and then sets the second subject image area in the second image based on:
a position of the first subject image area in the first image; and
a distance between the first image taking point and the second image taking point.

4. The visibility range measuring apparatus according to claim 2, wherein:
the first image taking point is located at a first distance from the target roadside object along the road;
the second image taking point is located at a second distance from the target roadside object along the road, wherein the second distance is smaller than the first distance; and
the subject image area setting means sets the second subject image area in the second image first, and then sets the first subject image area in the first image based on:
a position of the second subject image area in the second image; and
a distance between the first image taking point and the second image taking point.

5. The visibility range measuring apparatus according to claim 1, wherein:
the image computing means computes an edge intensity of the captured target roadside object as the image feature; and
the visibility range calculating means calculates the visibility range based on an edge intensity difference between the edge intensity of the captured target roadside object in the first image and the edge intensity of the captured target roadside object in the second image.

6. The visibility range measuring apparatus according to claim 5, further comprising conversion table storing means for storing a conversion table, wherein:
the visibility range is obtained by the visibility range calculating means from the conversion table, based on:
the distance between the first image taking point and the second image taking point; and
one of the edge intensity difference and the frequency component difference; and
the visibility range calculating means calculates the visibility range using the conversion table.

7. The visibility range measuring apparatus according to claim 1, wherein:
the image computing means computes a frequency component of the captured target roadside object as the image feature; and
the visibility range calculating means calculates the visibility range based on a frequency component difference between the frequency component of the captured target roadside object in the first image and the frequency component of the captured target roadside object in the second image.

8. The visibility range measuring apparatus according to claim 7, further comprising conversion table storing means for storing a conversion table, wherein:
the visibility range is obtained by the visibility range calculating means from the conversion table, based on:
the distance between the first image taking point and the second image taking point; and
one of the edge intensity difference and the frequency component difference; and
the visibility range calculating means calculates the visibility range using the conversion table.

9. The visibility range measuring apparatus according to claim 1, wherein the distance between the first image taking point and the second image taking point is obtained from a travel distance, which is traveled by the vehicle between the first and second image taking points.

10. The visibility range measuring apparatus according to claim 9, further comprising conversion table storing means for storing a conversion table, wherein:
the visibility range is obtained by the visibility range calculating means from the conversion table, based on:
the distance between the first image taking point and the second image taking point; and
one of the edge intensity difference and the frequency component difference; and
the visibility range calculating means calculates the visibility range using the conversion table.

11. A vehicle drive assist system comprising:
the visibility range measuring apparatus recited in claim 1; and
drive assisting means for assisting a driver of the vehicle with a drive operation of the vehicle using the visibility range, which is measured by the visibility range measuring apparatus.

12. A vehicle drive assist system comprising:
the visibility range measuring apparatus recited in claim 1; and
front information providing means for providing information about a state ahead of the vehicle to a driver of the vehicle using the visibility range, which is measured by the visibility range measuring apparatus.

13. The vehicle drive assist system according to claim 12, wherein the front information providing means includes an information supply timing changing means for changing a timing, with which the information is provided to the driver of the vehicle, based on the visibility range.
